(19) United States
(12) Patent Application Publication
(10) Pub. No.: US 2008/0078424 A1
(43) Pub. Date: Apr. 3, 2008

(54) METHODS TO ACCELERATE PHOTOIMAGEABLE MATERIAL STRIPPING FROM A SUBSTRATE

(75) Inventors: Roman Gouk, San Jose, CA (US); Phillip Peters, Santa Clara, CA (US); Han-Wen Chen, San Mateo, CA (US); James S. Papanu, San Rafael, CA (US)

Correspondence Address: APPLIED MATERIALS/BLAKELY, 1279 OAKMEAD PARKWAY, SUNNYVALE, CA, 94085-4040, US

(73) Assignee: APPLIED MATERIALS, INC.

(21) Appl. No.: 11/536,292

(22) Filed: Sep. 28, 2006

(51) Int. Cl. B08B 3/00

(52) U.S. Cl. 134/26; 134/29

(57) ABSTRACT

Embodiments of methods for decreasing the process time for photoresist stripping from photomasks are herein disclosed. In some embodiments, a stripping solution and a cleaning solution are consecutively applied in an alternating manner to a photomask to remove photoresist from the mask. The stripping solution and the cleaning solution can each be applied between 6 and 12 times. The stripping solution and the cleaning solution can be applied in a predetermined time interval from about 30 seconds to about 120 seconds and from about 8 seconds to about 30 seconds, respectively. The process can include a finishing process which can include a final cleaning operation, a rinsing operation and a drying operation.

### FIELD OF INVENTION

Photomask processing.

### BACKGROUND OF INVENTION

A “photoresist” is a light-sensitive organic polymer that is exposed by the photolithography process, then developed to produce a pattern which identifies some areas of the film to be etched. Photoresists are typically either negative or positive. Photoresist compositions are used in microlithographic processes for making miniaturized electronic components, such as in the fabrication of semiconductor device structures. The miniaturized electronic device structure patterns are typically created by transferring a pattern from a patterned masking layer overlying the semiconductor substrate rather than by direct write on the semiconductor substrate because of the time economy which can be achieved by blanket processing through a patterned masking layer. With regard to semiconductor device processing, the patterned masking layer may be a patterned photoresist layer or may be a patterned “hard” masking layer (typically an inorganic material or a high temperature organic material) which resides on the surface of the semiconductor device structure to be patterned. The patterned masking layer is typically created using another mask which is frequently referred to as a photomask. A photomask is typically a thin layer of a metal-containing layer (such as a chrome-containing, molybdenum-containing, or tungsten-containing material, for example) deposited on a glass or quartz plate. The photomask is patterned to contain a “hard copy” of the individual device structure pattern to be recreated on the masking layer overlying a semiconductor structure.

A photomask may be created by a number of different techniques, depending on the method of writing the pattern on the photomask. Due to the dimensional requirements of current semiconductor structures, the writing method is generally with a laser or e-beam. A typical process for forming a photomask may include: providing a glass or quartz plate, depositing a chrome-containing layer on the glass or quartz surface, depositing an antireflective coating (ARC) over the chrome-containing layer, applying a photoresist layer over the ARC layer, direct writing on the photoresist layer to form a desired pattern, developing the pattern in the photoresist layer, etching the pattern into the chrome layer, and removing the residual photoresist layer. Advanced photomask manufacturing materials frequently include combinations of layers of materials such as chromium, chromium oxide, chromium oxynitride, molybdenum, molybdenum silicide, and molybdenum tungsten silicide.

Processes for removing photoresist from a photomask include both dry stripping and wet stripping. Dry stripping can be performed in a chamber with oxygen (O₂) based plasmas at a temperature below 150° C. Stripping of positive photoresists from a photomask has been shown to be relatively successful by visual inspection. On the other hand, stripping of negative photoresists requires an additional wet stripping process. For either type of photoresist, it has been reported that plasma stripping with an oxygen based chemistry can result in degradation of the chromium oxide anti-reflective layer. Wet stripping can typically be performed using a process of applying a stripping solution and a subsequent cleaning solution to the photomask. This method can be very time consuming since the stripping solution removes the photoresist by oxidation and breaking carbon bonds, but not actually dissolving the photoresist. The photoresist is removed by being dissociated into lower molecular weight components (or oxidized completely to Cₒₓ) and subsequently rinsed off with the cleaning solution. The process can take up to 40 minutes and decreases the production rate of photomasks.

In a conventional photoresist wet-stripping method, a series of operations can be performed to remove the photoresist. In some methods, a stripping solution can be applied to the photomask, followed by a cleaning solution, followed by a rinsing solution, followed by drying of the photomask. One very long run or several shorter runs are generally required to completely remove the photoresist. A “run” refers to a stripping operation, followed by a cleaning operation, followed by a rinsing operation, followed by a drying operation. The stripping solution can be a wet or dry process. In applications in which a wet strip is used, a sulfuric hydrogen peroxide mixture (SPM) at 120° C. or ozone in deionized water (O3/DI) in a range from about 15 ppm to about 80 ppm can be used. SPM is a relatively fast stripper, but leaves sulfur residue on the photomask. In applications in which a dry strip is used, plasma ashing at about 150° C. to about 250° C. can be used. Plasma ashing can damage the ARC or cause photomask warpage. The cleaning solution can be, for example, deionized water or an ammonium peroxide mixture (APM). Examples of APMs include, but are not limited to, Standard Clean-1 (SC-1) and AM-clean™ (available from Applied Materials, Inc., Santa Clara, Calif.). The rinsing solution can typically be, for example, deionized water. Drying can be performed by spin drying and like techniques.

### EXAMPLE 1

In one experimental method, a series of runs was required to remove a 300 nanometer (nm) thick positive e-beam photoresist from a photomask. In run 1, O3/DI at 20 ppm was applied to a photomask for approximately 10 minutes, followed by cleaning with deionized water, rinsing with deionized water and spin-drying. Runs 2-4 were a repeat of run 1. The photoresist etch rate was measured at 7.5 nm/minute by visual inspection. Total run time for the O3/DI stripping operation was 40 minutes. Table 1 graphically illustrates the stripping method according to the above-described method.

TABLE 1

| | | | | |
|---|---|---|---|---|
| Run 1 | O3/DI strip - 10 minutes | DI clean | DI rinse | Dry |
| Run 2 | O3/DI strip - 10 minutes | DI clean | DI rinse | Dry |
| Run 3 | O3/DI strip - 10 minutes | DI clean | DI rinse | Dry |
| Run 4 | O3/DI strip - 10 minutes | DI clean | DI rinse | Dry |

### EXAMPLE 2

In another experimental method, at least two runs were required to remove a 300 nm thick positive e-beam photoresist from a photomask. In run 1, O3/DI at 20 ppm was applied to a photomask for approximately 10 minutes, followed by cleaning with AM-clean, rinsing with deionized water and spin-drying. For the final cleaning operation, DI water can be used with megasonic power at a frequency from about 5 revolutions per minute (rpm) (0.52 radians per second (rad/s)) to about 15 rpm (1.57 rad/s). Run 2 was a repeat of run 1. The photoresist etch rate was measured at 15 nm/min by visual inspection, Total run time for the O3/DI stripping operation was 20 minutes. Table 2 graphically illustrates the stripping method according to the above-described method.

TABLE 2

| | | | | |
|---|---|---|---|---|
| Run 1 | O3/DI strip - 10 minutes | AM-clean | DI rinse | Dry |
| Run 2 | O3/DI strip - 10 minutes | AM-clean | DI rinse | Dry |

### SUMMARY OF INVENTION

Embodiments of methods for decreasing the process time for photoresist stripping from photomasks are herein disclosed. In some embodiments, a stripping solution and a cleaning solution are consecutively applied in an alternating manner to a photomask to remove photoresist from the mask. The stripping solution and the cleaning solution can each be applied between 6 and 12 times. The stripping solution and the cleaning solution can be applied in a predetermined time interval from about 30 seconds to about 120 seconds and from about 8 seconds to about 30 seconds, respectively. The process can include a finishing process which can include a final cleaning operation, a rinsing operation and a drying operation.

### BRIEF DESCRIPTION OF DRAWINGS

FIGS. 1A-1E illustrate a process of fabricating a photomask.

FIG. 2 is a schematic illustration of a method of stripping a photoimageable material according to an embodiment of the present invention.

FIG. 2A illustrates an apparatus which can be used to strip a photoimageable material from a photomask according to embodiments of the present invention.

FIG. 2B illustrates a nozzle of the apparatus of FIG. 2A.

FIG. 3 illustrates a contactor device which may be used according to embodiments of the present invention.

### DETAILED DESCRIPTION

Methods for removing photoresist from a photomask during a photomask fabrication process can be performed in accordance with embodiments of the present invention. In one embodiment, a stripping operation and a cleaning operation can be performed on a photomask in a consecutively alternating manner until the photoresist is substantially or completely removed. In some embodiments, a final cleaning operation, a rinsing operation and a drying operation can be performed thereafter.

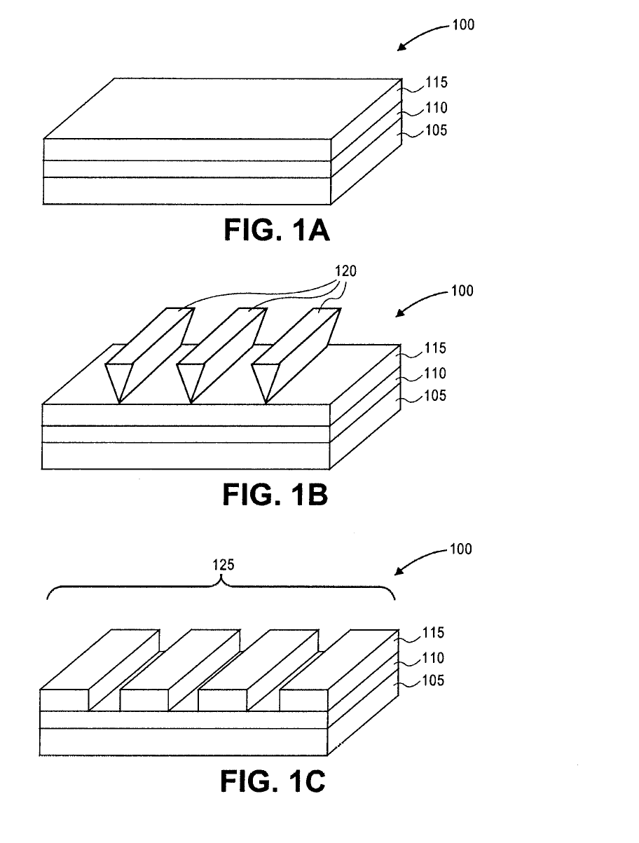

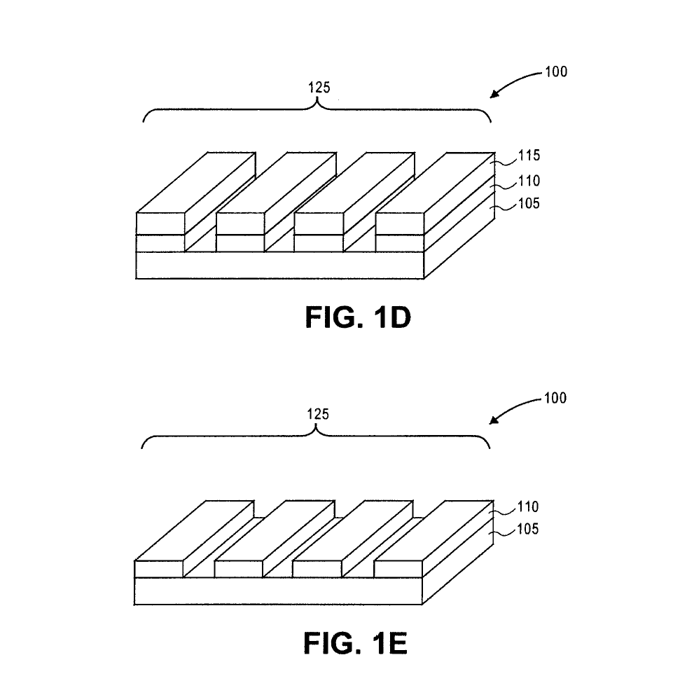

FIGS. 1A-1E illustrate a typical process flow for forming a photomask. In FIG. 1A, a substrate 105 is coated with a chrome-containing layer 110 followed by a coating of a photoresist (PR) layer 115 to form photomask template 100. A photomask template can include a quartz, a glass or a sapphire substrate, a metal-containing layer (such as a chrome-containing, molybdenum-containing, or tungsten-containing material, for example), an ARC layer and a photoresist layer. In one embodiment, the photoresist layer is combined with an anti-reflective coating material. The metal-containing layer can be from about 300 nm to about one micrometer (μm), while the photoresist layer can be from about 3000 Angstroms (A) to about 50,000 Å. Photomask sizes range from about 3 in² (7.62 cm²) to 11 in² (27.94 cm²), preferably 5 in² (12.7 cm²) to 6 in² (15.24 cm²). In one embodiment, substrate 105 is a quartz substrate between about 5 in² (12.7 cm²) to 6 in² (15.24 cm²). Chrome-containing layer 110 may be formed by a process such as sputtering. Photoresist layer 115 may be formed by a spinning process followed by polymerization and hardening.

In FIG. 1B, photomask template 100 is subjected to e-beam or laser lithography equipment to write (arrows 120) a predetermined pattern 125 (not shown in this figure) on the surface of photoresist layer 115. In FIG. 1C, developer chemicals can be applied to photomask template 100 to finalize predetermined pattern 125 over the photoresist area which was exposed by the e-beam or laser. The developer chemicals only remove photoresist in the areas subjected to the e-beam or laser. In FIG. 1D, dry or wet etching can be used to etch chrome-containing layer 110 in the areas in which the photoresist has been removed from photomask template 100. The area covered by the remaining photoresist remains unaffected.

In FIG. 1E, remaining photoresist is removed via a strip process (wet or dry), followed by cleaning and drying operations. At this stage, the surface of photomask template 100 is composed of dark areas covered by chrome-containing material or clear areas in which the chrome-containing material has been removed (naked quartz). The quartz is able to transmit incoming light from a light source. The patterned photomask template is typically referred to as a photomask.

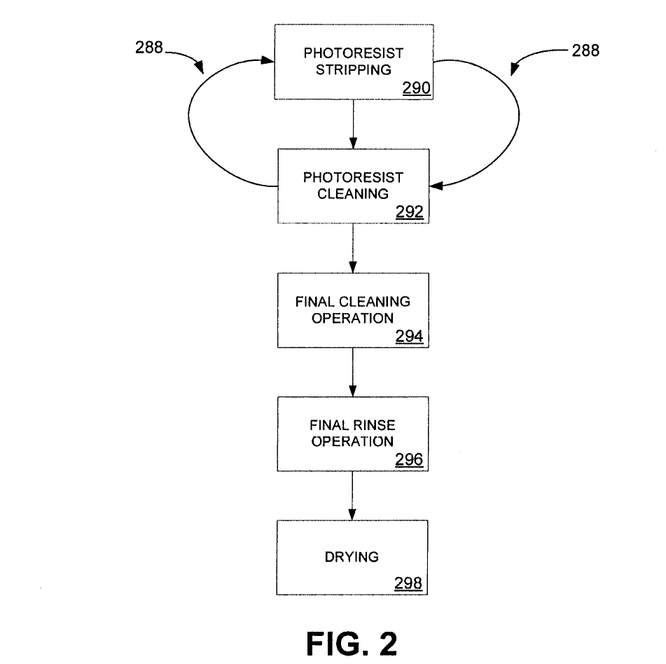

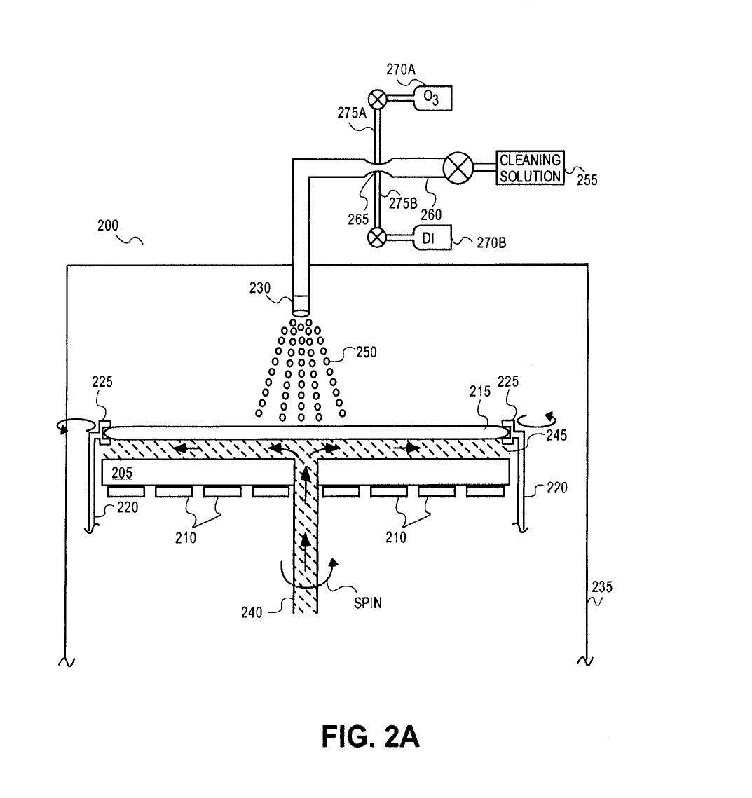

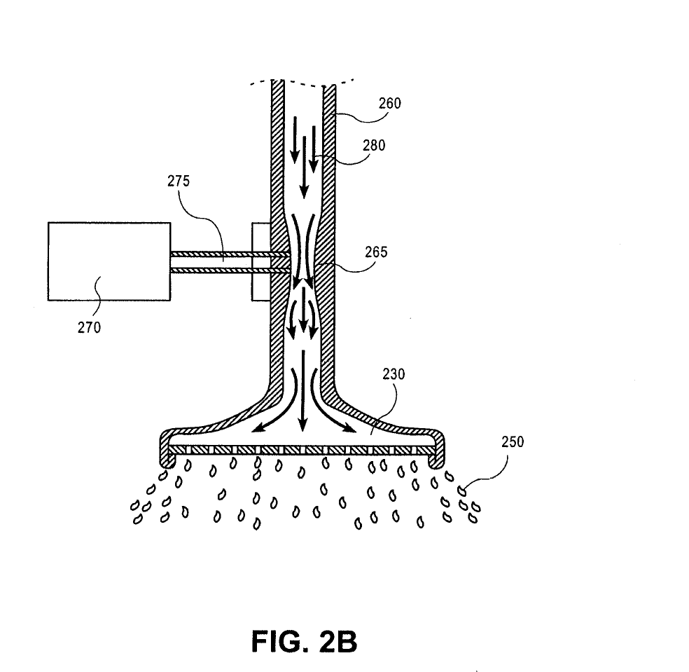

In some embodiments, photoresist layer 115 shown in FIG. 1D can be removed according to the process set forth in FIG. 2. Specifically, a stripping solution and a cleaning solution can be consecutively applied in an alternating manner for a predetermined time interval prior to a final cleaning operation, a rinse operation and a drying operation to remove photoresist from a photomask. The photoresist (or photoimageable material) can be a positive or a negative photoresist. Examples of positive photoresists include, but are not limited to, FEP and iP3600, while an example of a negative photoresist includes, but is not limited to, NEB.

As set forth in block 290, a photoresist stripping solution can be applied to a photomask. The stripping solution can be an SPM or O3/DI. In some embodiments, the stripping solution can be O3/DI in a range from about 15 ppm to about 35 ppm of ozone. In one embodiment, the stripping solution is O3/DI at 20 ppm. The stripping solution can be applied for a time interval from between about 30 seconds to about 60 120 seconds. In one embodiment, the stripping solution is applied for about 60 seconds. The stripping solution can be applied to the photomask while the photomask is spinning in a process apparatus such as the Applied Materials Tempest (available from Applied Materials, Santa Clara, United States). In some embodiments, the rotation during application of the stripping solution is between about 50 rpm (5.23 rad/s) and 300 rpm (31.42 rad/s). In an alternative embodiment, a dry strip, such as plasma ashing, can be performed in lieu of the wet strip.

Next, as set forth in block 292, a cleaning solution can be applied to the photomask. The cleaning solution can be an APM including, but not limited to, SC-1 or AM-clean. AM-clean is a solution resulting from the mixture of ammonium hydroxide (NH₄OH), hydrogen peroxide (H₂O₂), water (H₂O), a chelating agent and a surfactant. The mixture of ammonium hydroxide, surfactant and chelating agent is sold in a proprietary blend known as AM1 (available from Mitsubishi Chemical Corporation, Tokyo, Japan). As known by those skilled in the art, these compounds only dissociate into their respective ions and no chemical reactions occur among these compounds in a combined solution. The ammonium hydroxide, hydrogen peroxide and water can be present in concentrations defined by dilution ratios of between 5:1:1 to 1000:1:1, respectively. The ammonium hydroxide/hydrogen peroxide ratio can also be varied between 0.05:1 and 5:1. In some embodiments, no hydrogen peroxide is used at all. The ammonium hydroxide can be from a solution of about 28-29% by weight (w/w) of NH₃ to water. The hydrogen peroxide can be from a solution of about 31-32% w/w of H₂O₂ to water. The ammonium hydroxide and the hydrogen peroxide can remove particles and residual organic contaminates from a photomask after application of the stripping solution. According to some embodiments, the cleaning solution has an alkaline pH level between about 9 and 12, more specifically, between about 10 and 11.

The chelating agent can remove metallic ions from the photomask. Chelating agents are also known as complexing or sequestering agents. These agents have negatively charged ions called ligands that bind with free metal ions and form a combined complex that will remain soluble. The ligands bind to the free metal ions as follows:

M^{x+}+L^{y-}→M^{(x-y)}+L

### Common metallic ions that may be present include, but are not limited to copper, iron, nickel, aluminum, calcium, magnesium and zinc.

The surfactant can prevent reattachment or redeposition of particles on the photomask after they have been dislodged from the photomask. Preventing the reattachment of the particles is important because allowing the particles to reattach increases overall cleaning time. Surfactants are long hydrocarbon chains that typically contain a hydrophilic (polar water-soluble group) and a hydrophobic group (non-polar water-insoluble group). The surfactant may be non-ionic, anionic or a mixture of non-ionic and anionic compounds. Non-ionic means that the polar end of the surfactant has an electrostatic rather than an ionic charge and anionic means that the polar end of the surfactant has a negative ionic charge.

In one embodiment, the cleaning solution is AM1/H₂O₂/DI at a ratio of 1:2:80, respectively. The amount of ammonium hydroxide in the AM1 solution can be between about 28% to 29% w/w of NH₃/water and the hydrogen peroxide can be from about 31% to 32% w/w of H₂O₂/water, The cleaning solution can be applied in a time interval from between about 10 seconds to about 15 seconds. In one embodiment in which the photoresist is either positive or negative and the cleaning solution is AM-clean, the cleaning solution can be applied for about 10 seconds. The cleaning solution can be applied to the photomask while the photomask is spinning in a process apparatus. In some embodiments, the rotation during application of the cleaning solution is between about 50 rpm (5.23 rad/s) and 300 rpm (31.42 rad/s).

As shown by arrows 288 in FIG. 2, the stripping solution and the cleaning solution can be applied repeatedly until the photoresist is substantially or completely removed from the photomask. In some embodiments, the stripping solution and the cleaning solution can be applied in a consecutive alternating manner between 6 and 12 times each. In one embodiment in which the photoresist is either negative or positive and the cleaning solution is AM-clean, the stripping solution and the cleaning solution is each applied 9 times each to the photomask in a consecutive alternating manner. In some embodiments, the stripping solution can change throughout the process. For example, in one embodiment, a stripping solution of O3/DI can be applied to the photomask, followed by a cleaning solution, followed by a stripping solution of SPM, followed by a cleaning solution and thereafter repeated using different combinations of stripping solution until the photoresist is substantially or completed removed from the photomask. Similarly, in another embodiment, a stripping solution can be applied to the photomask, followed by a cleaning solution of AM-clean, followed by a stripping solution, followed by a cleaning solution of DI water and thereafter repeated using different combinations of cleaning solution until the photoresist is substantially or completed removed from the photomask. Any combination of stripping and cleaning solutions is contemplated by embodiments of the present invention. In some embodiments, a final cleaning operation, a rinsing operation and a drying operation may be performed after the photoresist is substantially or completely removed from the photomask by repeating a stripping operation and a cleaning operation in an alternating consecutive manner according to the embodiments previously described.

Following a series of consecutive alternating applications of a stripping solution and a cleaning solution, the photomask can be subjected to a final cleaning operation as set forth in block 294. The final cleaning operation can be performed with, for example, deionized water or an APM cleaning solution including SC-1 or AM-clean. In addition, using AM-clean, the final cleaning operation can be performed using megasonic power at between about 900 kilohertz (kHz) to about 1000 kHz and a frequency from about 5 rpm (0.52 rad/s) to about 30 rpm (3.14 rad/s) for between about 60 seconds and 120 seconds.

Following the final cleaning operation, the photomask can be rinsed as set forth in block 296. The rinsing operation can be performed with, for example, deionized water at a frequency from about 150 rpm (15.71 rad/s) to about 200 rpm (20.94 rad/s) for between about 60 seconds and 120 seconds. In one embodiment, the frequency for the rinsing operation is about 200 rpm (20.94 rad/s). Generally, no megasonic power is used in the rinsing operation.

Following the rinsing operation, the photomask can be subjected to a drying operation as set fort in block 298. The drying operation can be, for example, spin drying or like techniques. In spin drying, the photomask can rotate between about 700 rpm (73.30 rad/s) and about 1000 rpm (104.72 rad/s) for between about 40 seconds and 60 seconds. According to embodiments of the present invention, the time required for the photoresist stripping operation in photomask process can be reduced from between two to four times compared to conventional methods.

In an experimental method according to an embodiment of the present invention, one run was required to remove a 300 nm thick FEP positive e-beam photoresist from a photomask following an etching process. The run included consecutively alternating applications of O3/DI stripping solution at 20 ppm and AM-clean (abbreviated “AM” in Table 3 below) at a ratio of 1:2:80 AM1/H₂O₂/DI, respectively. The stripping solution was applied for about 60 seconds, while the cleaning solution was applied for about 10 seconds. The consecutive alternating operations were repeated nine times for a total run time of 10.5 minutes, including time to switch the stripping solution to the cleaning solution. The total time for the cumulative stripping solution applications was 9 minutes. Following application of the O3/DI solution and AM-clean solution in alternating operations, a final AM-clean solution was applied to the photomask, followed by a deionized water rinse, followed by spin-drying. The photoresist etch rate was measured at 33.3 nm/min by visual inspection by measuring the process time to remove the photoresist from the top surface of the photomask. Table 3 graphically illustrates the stripping method according to the above-described method.

TABLE 3

| | | | | | | | | | | | |
|---|---|---|---|---|---|---|---|---|---|---|---|
| Run 1 | O3/DI | AM | O3/DI | AM | O3/DI | AM | O3/DI | AM | O3/DI | AM | O3/DI |

| | | | | | | | | | | |
|---|---|---|---|---|---|---|---|---|---|---|
| Run 1 | AM | O3/DI | AM | O3/DI | AM | O3/DI | AM | AM-clean | DI Rinse | Dry |

TABLE 4

| | | No. of runs | Total O3/DI | PR |
|---|---|---|---|---|
| | | to strip | time | etch rate |
| Test | Process | PR | (min.) | (nm/min.) |
| 1 | 10 min O3/DI; DI clean; | 4 | 40 | 7.5 |
| | DI rinse; dry | | | |
| 2 | 10 min O3/DI; AM | 2 | 20 | 15 |
| | clean; DI rinse; dry | | | |
| 3 | 9x (1 min. O3/DI/10 sec. | 1 | 9 | 33.3 |
| | AM clean); AM clean; | | | |
| | DI rinse, dry | | | |

As can be observed in Table 4, test 3 performed in accordance with embodiments of the present invention resulted in an accelerated photoresist stripping process for both positive and negative photoresist relative to conventional methods. For both positive and negative photoresists, it is theorized that, in accordance with embodiments of the present invention, the abbreviated O3/DI operation oxidizes and dissociates the surface of the photoresist and the abbreviated APM operation removes the modified surface layer resulting in significantly enhanced removal rates.

Embodiments of the present invention can be performed using a single substrate apparatus such as that illustrated in FIG. 2A. Single substrate stripping and/or cleaning apparatus 200 shown in FIG. 2A includes a plate 205 with a plurality of acoustic or sonic transducers 210 located thereon. Plate 205 is preferably made of aluminum but can be formed of other materials such as, but not limited to, stainless steel and sapphire. Plate 205 is preferably coated with a corrosion resistant fluoropolymer such as Halar. In some embodiments, transducers 210 are attached to the bottom surface of plate 205 by an epoxy. Transducers 210 can substantially cover the entire bottom surface of plate 205, preferably at least 80% of plate 205. In one embodiments, there are four transducers 210 covering the bottom surface of plate 205 in a quadrant formation and preferably covering at least 80% of plate 205. The transducers 210 preferably generate megasonic waves in the frequency range above 350 kHz. The specific frequency is dependent on the thickness of the substrate and is chosen by its ability to effectively provide megasonics to both sides of the substrate. In some embodiments, the transducers are piezoelectric devices. The transducers 210 create acoustic or sonic waves in a direction perpendicular to the surface of a substrate 215. Substrate 215 can be, for example, a photomask.

Substrate 215 is horizontally held by a substrate support 220 and is positioned parallel to and spaced-apart from the top surface of plate 205. Substrate 215 can be clamped face-up by substrate support 220 by a plurality of clamps 225. Alternatively, the substrate can be supported on elastomeric pads on posts and held in place by gravity. Substrate 215 faces patterned side up towards a nozzle 230 for spraying chemicals thereon and the opposite side of substrate 215 faces plate 205.

In one embodiment, substrate 215 is held about 3 mm above the surface of plate 205 during a photoresist stripping process. In some embodiments, photoresist stripping process includes consecutively alternating applications of O3/DI stripping solution and AM-clean cleaning solution to substrate 215 prior to a final cleaning operation (see FIG. 2, 294) and a rinsing operation (see FIG. 2, 296) using nozzle 230. A drying operation can follow thereafter (see FIG. 2, 298). Stripping solution can be applied in a predetermined time interval, such as, for example, 30 seconds to about 120 seconds. Cleaning solution can also be applied in a predetermined time interval, such as, for example, from about 8 seconds to about 120 seconds. In some embodiments, stripping solution can be 20 ppm and AM-clean can be at a ratio of 1:2:80 AM1/H₂O₂/DI, respectively. In some embodiments, substrate support 220 can horizontally rotate or spin substrate 215 about its central axis at a rate of between 0-6000 rpms. Spinning can be used in the photoresist stripping application, photoresist cleaning application as well as the final cleaning process, final rinse process and drying. Apparatus 200 can include a sealable chamber 235 in which nozzle 230, substrate 215, and plate 205 are located as shown in FIG. 2A.

In an embodiment of the present invention, deionized water is fed through a feed-through channel 240 of plate 205 and fills the gap between the backside of substrate 215 and plate 205 to provide a water-filled gap 245 through which acoustic waves generated by transducers 210 can travel to substrate 215. In some embodiments, the feed channel 240 is slightly offset from the center of the substrate by approximately 1 mm. The backside of the substrate may alternately be rinsed with other solutions during this operation. In an embodiment of the present invention, DI water fed between substrate 215 and plate 205 is degassed so that cavitation is reduced in the DI water-filled gap 245 where the acoustic waves are strongest thereby reducing potential damage to substrate 215. DI water can be degassed by well known techniques at either the point of use or back at the source.

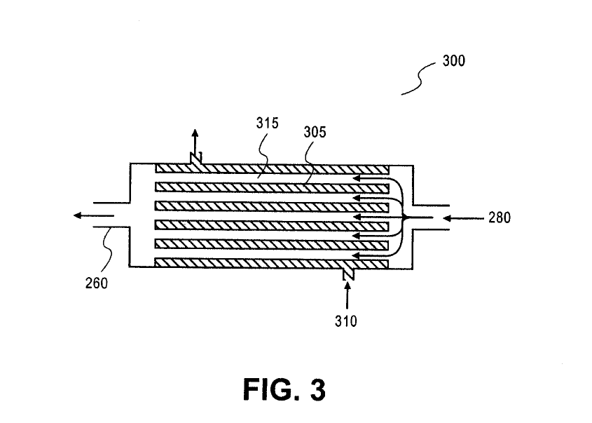

Stripping solutions and rinsing water such as DI water can be expelled through nozzle 230 to generate a spray 250 on substrate 215. In some embodiments, nozzle 230 can move in a horizontal plane to uniformly apply chemical solutions to substrate 215. In some embodiments, tank 255 containing a solution for cleaning (an APM or deionized water) is coupled to conduit 260 which feeds into nozzle 230. In an embodiment of the present invention, the diameter of conduit 260 has a reduced cross-sectional area or a “venturi” 265 that is shown in more detail in FIG. 2B, in a line before spray nozzle 230 at which point a gas (such as ozone) from tank 270a that travels through conduit 275a, is dissolved in deionized water from tank 270b traveling through conduit 275b as it travels to nozzle 230. “Venturi” 265 enables a gas to be dissolved into a fluid flow 280 (see FIG. 2B) at gas pressure less than the pressure of the liquid flowing through conduit 260. The venturi 265 creates dissolution under pressure locally because of the increase in flow rate at the venturi. In an alternate embodiment, gases are dissolved into the solution by a hydrophobic contactor device 300 as shown in FIG. 3. This contactor device 300 is put into the conduit 260. Contactor device 300 has a hydrophobic membrane conduit 300 which allows gasses to pass through but not water. Gas 310 is fed into membrane conduit 305 where the gas dissolves into the liquid passing through the area 315.

Prior to being fed through nozzle 230, deionized water can be ozonated at point of use by dissolving O₃ gas into the deionized water forming a photoresist stripping solution (see FIG. 2, 290) for application to substrate 215 thereof. This may be done with a venturi device as described with respect to FIG. 2B or with a membrane device as described with respect to FIG. 3. Dissolved ozone (O₃) is added to the deionized water in a concentration of about 20 ppm or greater to serve as an oxidant. The solution should have an oxidation potential sufficient to oxidize the most noble metal in the solution. Copper (Cu²⁺), with a standard reduction potential of 0.3V, is usually the most noble metal present. Therefore a standard reduction potential of greater than 0.5V is desired. Ozone will solvate the metal ions and prevents precipitation by oxidizing the metal ions that are in solution. This will help decrease the processing time by making the rinsing more effective. The use of ozone is also efficient and cost effective. In an embodiment of the present invention, the DI rinse water is degassed prior to dissolving ozone into the deionized water.

Although discussed with respect to a photomask, embodiments of the present invention can be applied to other substrates, such as, but not limited, semiconductor wafers. One of ordinary skill in the art will appreciate that the embodiments of the present invention can be performed on a variety of different substrates.

In the foregoing specification, specific embodiments have been described. It will, however, be evident that various modifications and changes can be made thereto without departing from the broader spirit and scope of the appended claims. The specification and drawings are, accordingly, to be regarded in an illustrative rather than a restrictive sense.

What is claimed is:

1. A method comprising:
providing a substrate comprising a photoimageable material thereon;
applying a first stripping solution to the photoimageable material;
after applying the first stripping solution, applying a first cleaning solution to the photoimageable material;
after applying the first cleaning solution, applying a second stripping solution to the photoimageable material;
after applying the second stripping solution, applying a second cleaning solution to the photoimageable material; and
rinsing the substrate.

2. The method of claim 1, further comprising, prior to the rinsing, performing a final cleaning operation to the substrate.

3. The method of claim 1, further comprising, after the rinsing, performing a drying operation to the substrate.

4. The method of claim 1, wherein the cleaning solution comprises an ammonium peroxide mixture solution.

5. The method of claim 4, wherein the ammonium peroxide mixture solution is one of Standard Clean 1 or AM-clean.

6. The method of claim 1, wherein at least one of the first and second stripping solutions is an ozone deionized water solution between 15 parts per million and 80 parts per million.

7. The method of claim 1, further comprising alternately applying at least one of the first or second stripping solutions and at least one of the first or second cleaning solutions between 6 and 12 times each.

8. The method of claim 1, wherein at least one of the first or second stripping solutions and at least one of the first or second cleaning solutions is applied in a predetermined time interval.

9. The method of claim 8, wherein at least one of the first or second stripping solutions is applied between 30 seconds and 120 seconds and at least one of the cleaning solutions is applied between 8 seconds and 30 seconds.

10. The method of claim 9, wherein at least one of the first or second stripping solutions is applied between 45 seconds and 65 seconds and at least one of the cleaning solutions is applied for 10 seconds.

11. The method of claim 1, wherein the photoimageable material is one of a positive photoresist and a negative photoresist.

12. The method of claim 1, wherein the photoimageable material is patterned on the substrate.

13. The method of claim 1, wherein the photoimageable material is between 3000 Angstroms and 50,000 Angstroms.

14. The method of claim 1, wherein the substrate is a glass plate coated on one side with a chrome-containing material or a quartz plate coated on one side with a chrome-containing material.

15. The method of claim 1, wherein a total processing time is between 6 minutes and 15 minutes.

16. The method of claim 1, wherein the final cleaning operation is performed with AM-clean, the rinsing operation is performed with deionized water, and the drying operation is spin drying.

17. The method of claim 1, wherein the first stripping solution and the second stripping solution are the same.

18. A method comprising:
applying a stripping solution comprising ozone deionized water at 20 parts per million to a substrate with a photoimageable material thereon during a first time interval;
applying a cleaning solution comprising an ammonium hydroxide solution to the substrate during a second time interval; and
repeating the applications in consecutive intervals prior to performing a final cleaning operation, a rinsing operation and a drying operation to the substrate.

19. The method of claim 18, wherein the ammonium hydroxide solution is AM-clean comprising a solution of AM1/hydrogen peroxide/deionized water at a ratio of 1:2:80 wherein the AM-1 is 28% to 29% by weight of ammonia to water and the hydrogen peroxide is from about 31% to 32% by weight of hydrogen peroxide to water.

20. The method of claim 18, wherein the repeating is between 6 and 12 times.

21. The method of claim 18, wherein the total application time is less than 15 minutes.

22. The method of claim 18, wherein the first time interval is between 30 seconds and 120 seconds.

23. The method of claim 18, wherein the second interval is between 8 seconds and 15 seconds.

24. The method of claim 18, wherein the photoimageable material is one of a positive photoresist and a negative photoresist.

25. The method of claim 18, wherein the photoimageable material is patterned on the substrate.

26. The method of claim 18, wherein the photoimageable material is between 3000 Angstroms and 50,000 Angstroms.

27. The method of claim 18, wherein the substrate is a glass plate coated on one side with a chrome-containing material or a quartz plate coated on one side with a chrome-containing material.

28. The method of claim 18, wherein the final cleaning operation is performed with AM-clean, the rinsing operation is performed with deionized water, and the drying operation is spin drying.
